(19) United States
(12) Patent Application Publication
(10) Pub. No.: US 2025/0069195 A1
(43) Pub. Date: Feb. 27, 2025

(54) DEBLURRING METHOD AND APPARATUS BASED ON UNSUPERVISED LEARNING AND LATENT SPACE PROCESSING

(71) Applicant: Electronics and Telecommunications Research Institute, Daejeon (KR)

(72) Inventors: Hyun Yong Lee, Daejeon (KR); Seok Kap Ko, Daejeon (KR); Nack Woo Kim, Daejeon (KR); JUNGI LEE, Daejeon (KR); YUMIN HWANG, Daejeon (KR)

(21) Appl. No.: 18/757,222

(22) Filed: Jun. 27, 2024

(30) Foreign Application Priority Data
Aug. 23, 2023 (KR) 10-2023-0110525

(51) Int. Cl. G06T 5/60; G06T 5/73

(52) U.S. Cl. CPC G06T 5/60; G06T 5/73; G06T 2207/20024; G06T 2207/20081; G06T 2207/20084

(57) ABSTRACT

The present invention relates to a deblurring method and apparatus based on unsupervised learning and latent space processing. An unsupervised learning method of a deblurring model according to the present invention includes inputting an input image into a deblurring model to generate a restored image, calculating an error between the input image and the restored image, and training the deblurring model based on the error. A latent space processing-based deblurring method according to the present invention includes inputting a deblurring target image into an encoder, applying an image filtering technique to an output of the encoder, and inputting the output of the encoder, to which the image filtering technique has been applied, into a decoder to generate a deblurred image.

### CROSS-REFERENCE TO RELATED APPLICATION

This application claims priority under 35 U.S.C. § 119 to Korean Patent Application No. 10-2023-0110525, filed on Aug. 23, 2023, in the Korean Intellectual Property Office, the disclosure of which is incorporated herein by reference in its entirety.

### BACKGROUND

### 1. Field of the Invention

The present invention relates to an image deblurring method and apparatus for improving the quality of blurred images.

### 2. Discussion of Related Art

Image deblurring refers to a technique that restores sharpness to images that are blurred due to camera shake.

Conventional image deblurring techniques may be broadly classified into two methods.

The first method operates to predict a blur kernel. The predicted blur kernel may be used to convert a blurry image into a sharp image. The method generally attempts to predict the blur kernel by applying mathematical formulas to blurry images.

The second method operates to directly restore a sharp image from a blurry image based on a deep learning model. Most of the latest deblurring techniques fall into this category.

The conventional deep learning model-based techniques are mostly supervised learning methods and require a data set for model training. In other words, a deep learning model needs to be trained to restore a sharp image from a blurry image, and to this end, a blurry image and a sharp image corresponding thereto are needed.

However, a sharp image corresponding to the blurry image is not always present. In other words, there may be cases in which a sharp image corresponding to a blurry image is not obtained.

In addition, blurry image and sharp image data sets that are publicly available may be used to train a deep learning model, or a required data set may be generated through simple experiments, but the obtained data set may not always be representative of a target to which the model is applied.

In the above-described case, it is difficult to apply the conventional supervised learning-based deblurring techniques.

### SUMMARY OF THE INVENTION

The present invention is directed to providing an image deblurring method and apparatus based on unsupervised learning and latent space processing that do not require separate sharp images for model training while utilizing a deep learning model.

The present invention is directed to providing an image deblurring method and apparatus based on an unsupervised learning and latent space processing that are capable of performing deblurring by training an encoder-decoder model through an unsupervised method and applying a simple image filtering technique to an output of the trained encoder.

The technical objectives of the present invention are not limited to the above, and other objectives may become apparent to those of ordinary skill in the art based on the following description.

According to an aspect of the present invention, there is provided an unsupervised learning method of a deblurring model, which is a method of training an image deblurring model. The method includes: preprocessing an input image; inputting the preprocessed image into a deblurring model to generate a restored image; calculating an error between the preprocessed image and the restored image; and training the deblurring model based on the error.

The input image may be a black and white image or an RGB image.

The preprocessing of the input image may include applying a sharpening technique to the input image to sharpen edges of the input image.

The deblurring model may include an encoder and a decoder. In this case, the generating of the restored image may include: inputting the preprocessed image into the encoder to obtain an output of the encoder and inputting the output of the encoder into the decoder to generate the restored image.

The calculating of the error may include calculating the error using a calculation method related to at least one of mean squared error (MSE) and structural similarity index measure (SSIM).

According to an aspect of the present invention, there is provided a latent space processing-based deblurring method, which is a method of deblurring an image using a trained deblurring model, the method including: inputting a deblurring target image into an encoder; applying an image filtering technique to an output of the encoder; and inputting the output of the encoder, to which the image filtering technique has been applied, into a decoder to generate a deblurred image. The encoder and the decoder constitute a deblurring model and are trained through an unsupervised learning method.

The output of the encoder may be an image whose size is reduced compared to a size of the deblurring target image.

The deblurred image may be an image that has the same size as the deblurring target image.

The image filtering technique may be a sharpening technique.

According to an aspect of the present invention, there is provided an apparatus for deblurring based on unsupervised learning and latent space processing, the apparatus including: a memory in which instructions readable by a computer are stored; and at least one processor implemented to execute the instructions. The at least one processor may be configured to execute the instructions to: preprocess an input image; input the preprocessed image into a deblurring model to generate a restored image; calculate an error between the preprocessed image and the restored image; and train the deblurring model based on the error.

### BRIEF DESCRIPTION OF THE DRAWINGS

The above and other objects, features and advantages of the present invention will become more apparent to those of ordinary skill in the art by describing exemplary embodiments thereof in detail with reference to the accompanying drawings, in which:

FIG. 1 is a conceptual diagram illustrating a deblurring method based on unsupervised learning and latent space processing proposed by the present invention;

FIG. 2 is a conceptual diagram illustrating an unsupervised learning method of a deblurring model proposed by the present invention;

FIG. 3 is a conceptual diagram illustrating an unsupervised learning method of a deblurring model based on a preprocessed image proposed by the present invention;

FIG. 4 is a conceptual diagram illustrating a latent space processing-based deblurring method proposed by the present invention;

FIG. 5 is a diagram illustrating an example of application of a latent space processing-based deblurring method proposed by the present invention;

FIG. 6 is a flowchart illustrating an unsupervised learning method of a deblurring model according to an embodiment of the present invention;

FIG. 7 is a flowchart for describing a latent space processing-based deblurring method according to an embodiment of the present invention; and

FIG. 8 is a block diagram illustrating a configuration of a deblurring apparatus based on unsupervised learning and latent space processing according to an embodiment of the present invention.

### DETAILED DESCRIPTION OF EXEMPLARY EMBODIMENTS

Hereinafter, the advantages and features of the present invention and ways of achieving them will become readily apparent with reference to the detailed description of the following embodiments in conjunction with the accompanying drawings. However, the present invention is not limited to such embodiments and may be embodied in various forms. The embodiments to be described below are provided only to complete the disclosure of the present invention and assist those of ordinary skill in the art in fully understanding the scope of the present invention, and the scope of the present invention is defined only by the appended claims. Terms used herein are used to aid in the description and understanding of the embodiments and are not intended to limit the scope and spirit of the present invention. It should be understood that the singular forms “a” and “an” also include the plural forms unless the context clearly dictates otherwise. The terms “comprise,” “comprising,” “include,” and/or “including” used herein specify the presence of stated features, integers, steps, operations, elements, components and/or groups thereof and do not preclude the presence or addition of one or more other features, integers, steps, operations, elements, components, and/or groups thereof.

In the description of the present invention, when it is determined that a detailed description of related technology may unnecessarily obscure the gist of the present invention, the detailed description will be omitted.

Hereinafter, example embodiments of the present invention will be described with reference to the accompanying drawings in detail. For better understanding of the present invention, the same reference numerals are used to refer to the same elements through the description of the figures.

### 1. Basic Structure of Deblurring Based on Unsupervised Learning and Latent Space Processing

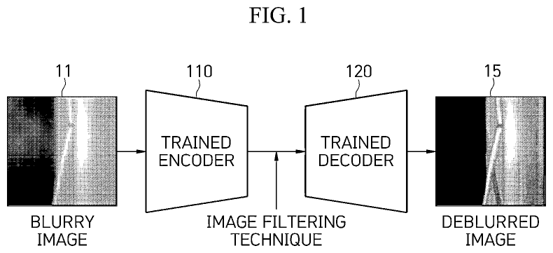

Referring to FIG. 1, the basic structure of deblurring based on unsupervised learning and latent space processing proposed by the present invention is described.

An encoder 110 and a decoder 120 are trained to understand the features of a blurry image 11 obtained in advance.

A deblurred image 15 may be generated from the blurry image 11 using the trained encoder 110 and the trained decoder 120.

The input image 11 to the encoder 110 may be a blurry image that requires deblurring. The encoder 110 extracts features from the input image 11 based on pre-learned weights. Additionally, an output of the encoder 110 is subject to an image filtering technique to remove or reduce blur elements of the output of the encoder 110. The decoder 120 may restore the deblurred image 15 from the output of the encoder 110, which has been subjected to the filtering, based on pre-learned weights.

### 2. Unsupervised Learning of Deblurring Model

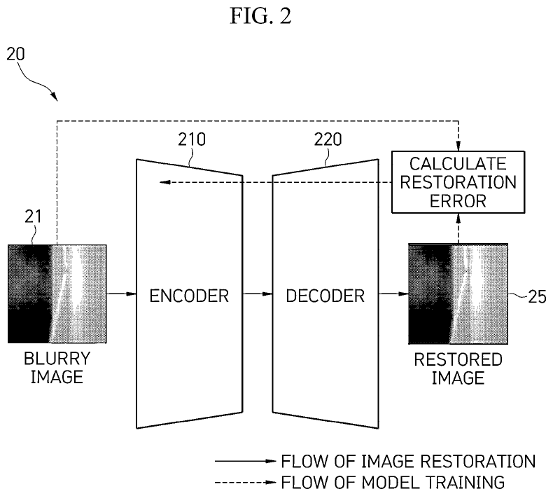

FIG. 2 is a conceptual diagram illustrating an unsupervised learning method of a deblurring model proposed by the present invention. The unsupervised learning method of the deblurring model proposed by the present invention is characterized by not requiring a sharp image corresponding to a blurry image for training of a deblurring model.

An image 21 used for training a deblurring model 20 may be a set of blurry images showing various levels of blurriness (or sharpness). Known techniques may be used to express the level of blur or sharpness. The blurry image 21 used for training the deblurring model 20 may be three-dimensional data, such as an RGB image, or one-dimensional data, such as a black and white image.

An encoder 210 or a decoder 220 may be implemented using various artificial neural networks, such as a convolutional neural network (CNN), a recurrent neural network (RNN), a fully connected network, and the like.

An output of the encoder 210 may be data having a dimension that is larger than, less than, or equal to that of the input image 21. The output of the encoder 210 may have a size that is greater than, smaller than, or equal to that of the input image 21.

The decoder 220 may be a model that restores an image 25 having the same dimension and size as those of the input image 21 based on the output of the encoder 210.

Based on the encoder-decoder structure, training of the deblurring model 20 may proceed such that the difference (which may be referred to as a “restoration error”) between the input image 21 and the restored image 25 is reduced.

For example, the difference between the input image 21 and the restored image 25, that is, the restoration error, may be calculated based on mean squared error (MSE), structural similarity index measure (SSIM), and the like.

The purpose of training the deblurring model through the above-described procedure is to better understand target blurry images to which the model is applied.

For example, when developing a model for deblurring a wind blade X-ray image captured by a drone, the training of the deblurring model may proceed based on multiple wind blade X-ray images captured by a drone.

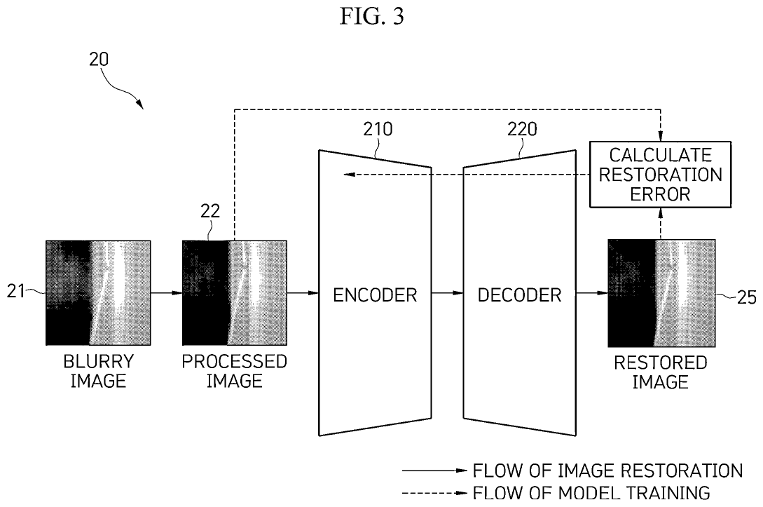

FIG. 3 is a conceptual diagram illustrating an unsupervised learning method of a deblurring model based on a preprocessed image proposed by the present invention. That is, FIG. 3 is a conceptual diagram of an unsupervised learning method of a deblurring model performed based on an image derived by applying an image processing technique to a blurry image.

In performing the above-described training on the deblurring model 20, rather than directly using an obtained blurry image 21, a simple image processing technique may be applied to the blurry image 21, and the resulting processed image 22 may be used as an input image of the encoder 210.

In processing the blurry image 21, various image processing techniques may be applied. For example, edges may be made sharper by applying a sharpening technique.

Using the image 22, which is obtained by applying the image processing technique to the blurry image 21, to train the deblurring model enables the deblurring model 20 to better understand features included in the target image 21 through the image processing technique.

### 3. Latent Space Processing-Based Deblurring

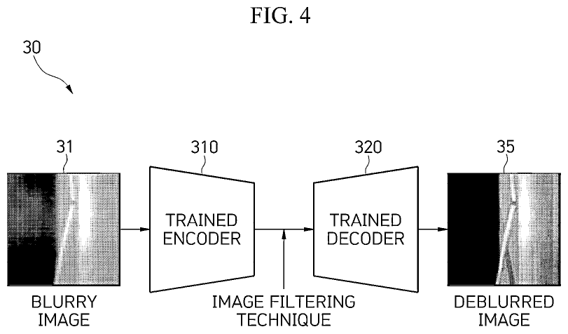

FIG. 4 is a conceptual diagram illustrating a latent space processing-based deblurring method proposed by the present invention.

After training a deblurring model 30 based on the unsupervised learning method described above, deblurring may be performed by applying an image filtering technique to the trained deblurring model 30.

An input image 31 of the trained deblurring model 30 of the encoder-decoder structure may be the same as the input image used for the unsupervised method-based model training.

For example, when the deblurring model 30 is trained with an original blurry image, the original blurry image may be used as the input image 31.

To implement a deblurring function based on the trained deblurring model 30, an image filtering technique may be applied to an output of the trained encoder 310. For example, image filtering techniques, such as smoothing and sharpening, may be applied.

The above-described image filtering technique may be applied to an intermediate output within layers of the encoder 310 or an intermediate output within layers of the decoder 320, in addition to the final output of the trained encoder 310.

In addition, the above-described image filtering technique may be applied to the final output of the trained encoder 310, and may additionally be applied to the intermediate output within the layers of the encoder 310 or the intermediate output within the layers of the decoder 320 in a step-wise manner.

The purpose of applying the image filtering technique to the encoder-decoder model 30 trained using an unsupervised learning method is to complete the deblurring function of the input image 31.

In other words, the core of the present invention is to first train an encoder-decoder type deblurring model to enable better understanding of the features of a blurry image that is the target of deblurring, then apply an image filtering technique to an output of the encoder or other outputs of intermediate layers to remove/reduce blur elements of the output, and then use the output, from which the blur elements are removed/reduced, as an input to the decoder so that deblurring is performed on an input image.

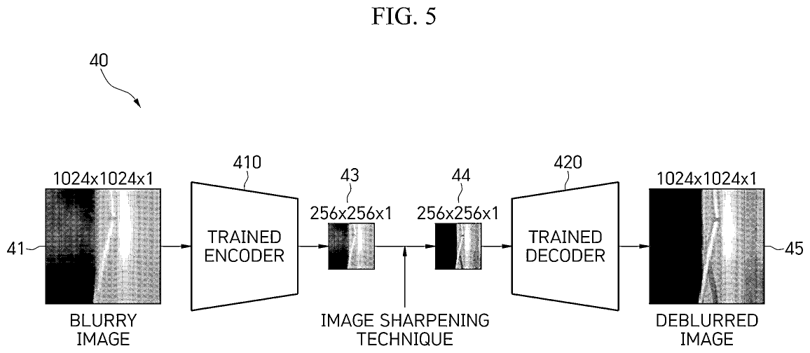

FIG. 5 is a diagram illustrating an example of application of a latent space processing-based deblurring method proposed by the present invention.

In the example shown in FIG. 5, an input image 41 to an encoder 410 is a one-dimensional X-ray image with a size of 1024×1024.

A deblurring model 40 composed of an encoder 410 and a decoder 420 may be trained to restore blurry X-ray images that are obtained in advance.

In this case, a latent space of the deblurring model 40, that is, an output 43 of the encoder 410, may be a one-dimensional image with a size of 256×256 that may be an image with a reduced scale compared to the input image 41.

As shown in FIG. 5, image sharpening processing may be applied to the output 43 of the encoder 410. The sharpened output of the encoder 410 may be used as an input 44 of the decoder 420, and the decoder 420 may restore a one-dimensional image 45 with the same size of 1024×1024 as the encoder input 41.

To summarize the above-described example, the encoder 410 is trained to implement a downsampling function, and the decoder 420 is trained to implement an upsampling function. That is, the deblurring model 40 shown in FIG. 5 downsamples the input image 41 through the encoder 410, removes/reduces blur elements through sharpening, and then upsamples the output of the encoder 410 through the decoder 420, to thereby implement a deblurring function.

### 4. Embodiments of the Present Invention

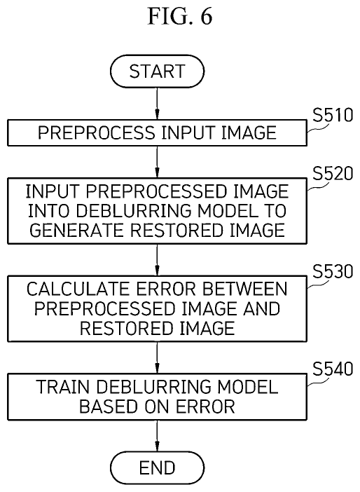

FIG. 6 is a flowchart illustrating an unsupervised learning method of a deblurring model according to an embodiment of the present invention.

The unsupervised learning method of the deblurring model according to the embodiment of the present invention includes operations S510 to S540. The unsupervised learning method of the deblurring model shown in FIG. 6 is based on one embodiment, and operations of the unsupervised learning method of the deblurring model according to the present invention are not limited to the embodiment shown in FIG. 6, and some operations may be added, changed, or deleted as needed. For example, operation S510 may be deleted, and in operation S520, an input image may be input into the deblurring model without being preprocessed.

The unsupervised learning method of the deblurring model according to the embodiment of the present invention may be performed by a deblurring apparatus 1000 based on unsupervised learning and latent space processing (hereinafter abbreviated as a “deblurring apparatus”).

The deblurring model includes an encoder and a decoder, and the encoder or the decoder may be implemented using various artificial neural networks, such as a CNN, an RNN, a fully connected network, and the like.

Operation S510 is an operation of preprocessing an input image.

The input image may be an image used for training a deblurring model, and may be a set of images showing various levels of sharpness. Known techniques may be used to express the level of sharpness. The images included in the input image may be an RGB image or a black and white image.

The deblurring apparatus 1000 may apply a simple image processing technique to the input image. For example, the deblurring apparatus 1000 applies a sharpening technique as an image processing technique to sharpen the edges of the input image.

Operation S520 is an operation of inputting the preprocessed image into the deblurring model to generate a restored image.

The deblurring apparatus 1000 inputs the preprocessed image into the deblurring model including the encoder and the decoder to generate the restored image. The deblurring apparatus 1000 inputs the preprocessed image into the encoder and inputs an output of the encoder into the decoder to generate the restored image.

When operation S510 is not performed, the deblurring apparatus 1000 inputs the input image into the deblurring model to generate a restored image. That is, the deblurring apparatus 1000 inputs the input image into the encoder and inputs an output of the encoder into the decoder to generate a restored image.

Operation S530 is an operation of calculating an error between the preprocessed image and the restored image.

The deblurring apparatus 1000 calculates the error (a restoration error) between the preprocessed image and the restored image. The restoration error may be calculated based on MSE, SSIM, and the like.

When operation S510 is not performed, the deblurring apparatus 1000 calculates the error between the input image and the restored image.

Operation S540 is an operation of training the deblurring model based on the error.

The deblurring apparatus 1000 trains the encoder and the decoder included in the deblurring model using the error calculated in operation S530. The deblurring apparatus 1000 may train the encoder and the decoder in a direction that reduces the error calculated in operation S530.

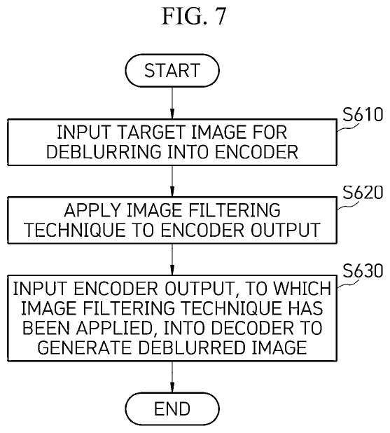

FIG. 7 is a flowchart for describing a latent space processing-based deblurring method according to an embodiment of the present invention.

Referring to FIGS. 7, the latent space processing-based deblurring method according to the embodiment of the present invention includes operations S610 to S630. The latent space processing-based deblurring method shown in FIG. 7 is based on one embodiment, and operations of the latent space processing-based deblurring method according to the present invention are not limited to the embodiment shown in FIG. 7, and some operations may be added, changed, or deleted as needed. For example, operation S620 may be deleted.

The latent space processing-based deblurring method according to the embodiment of FIG. 7 may use the deblurring model trained according to the embodiment of FIG. 6. Therefore, the deblurring method of FIG. 7 may be executed after the unsupervised learning method of FIG. 6 is executed, and the unsupervised learning method according to the embodiment of FIG. 6 and the deblurring method according to the embodiment of FIG. 7 may be combined to constitute one deblurring method.

The deblurring model used to perform the deblurring method according to the embodiment of FIG. 7 includes a trained encoder and a trained decoder.

The latent space processing-based deblurring method according to the embodiment of the present invention may be performed by the deblurring apparatus 1000.

Operation S610 is an operation of inputting a deblurring target image into the encoder.

The deblurring apparatus 1000 inputs the deblurring target image into the trained encoder to obtain an encoder output. For example, the deblurring target image may be a blurry image. The output of the encoder may be a feature or an image. For example, the output of the encoder may be an image whose size is reduced compared to the deblurring target image.

Operation S620 is an operation of applying an image filtering technique to the encoder output.

The deblurring apparatus 1000 applies an image filtering technique to the encoder output. For example, the deblurring apparatus 1000 may apply image filtering techniques, such as smoothing and sharpening, to the encoder output. When the deblurring apparatus 1000 applies sharpening to the encoder output, blur elements of the encoder output are removed or reduced.

Operation S630 is an operation of inputting the encoder output, to which the image filtering technique has been applied, into the decoder to generate a deblurred image.

The deblurring apparatus 1000 inputs the encoder output, to which the image filtering technique has been applied, into the decoder to generate a deblurred image. In this case, the deblurred image may be an image that has the same size as the deblurring target image.

The unsupervised learning method of the deblurring model and the latent space processing-based deblurring method have been described above with reference to the flowcharts presented in the drawings. While the above method has been shown and described as a series of blocks for the purpose of simplicity, it is to be understood that the present invention is not limited to the order of the blocks, and that some blocks may be executed in a different order from those shown and described herein or executed concurrently with other blocks, and various other branches, flow paths, and sequences of blocks that achieve the same or similar results may be implemented. In addition, not all illustrated blocks may be required for implementation of the method described herein.

Meanwhile, in the description with reference to FIGS. 6 and 7, each operation may be further divided into a larger number of sub-operations or combined into a smaller number of operations according to examples of implementation of the present invention. In addition, some of the operations may not be performed or the order of operations may be changed, as needed. In addition, even in the case of omitted content, the content of FIGS. 1 to 5 may be applied to the content of FIGS. 6 and 7. In addition, the content of FIGS. 6 and 7 may be applied to the content of FIGS. 1 to 5.

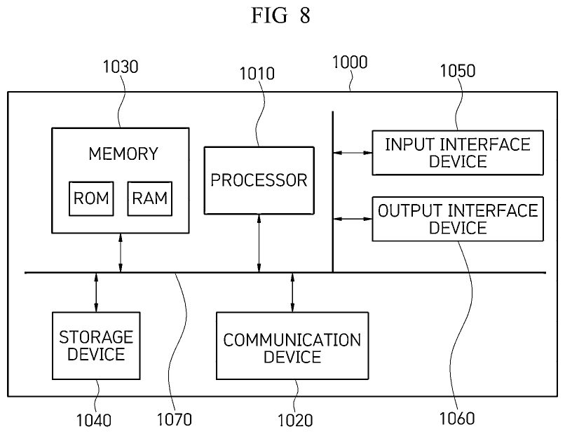

FIG. 8 is a block diagram illustrating a configuration of a deblurring apparatus based on unsupervised learning and latent space processing according to an embodiment of the present invention. The deblurring apparatus 1000 is an apparatus for performing the unsupervised learning method of the deblurring model and the latent space processing-based deblurring method according to the embodiment of the present invention. The deblurring apparatus 1000 may be implemented in the form of a computer system.

Referring to FIG. 8, the deblurring apparatus 1000 may include at least one of a processor 1010, a memory 1030, an input interface device 1050, an output interface device 1060, and a storage device 1040 that communicate through a bus 1070. The deblurring apparatus 1000 may further include a communication device 1020 coupled to a network. The deblurring apparatus 1000 shown in FIG. 8 is based on one embodiment, and elements of the deblurring apparatus 1000 are not limited to the embodiment shown in FIG. 8, and elements may be added, changed, or deleted as needed.

The processor 1010 may be a central processing unit (CPU) or a semiconductor device for executing instructions stored in the memory 1030 and/or storage device 1040. The memory 1030 and the storage device 1040 may include various forms of volatile or nonvolatile media. For example, the memory may include a read only memory (ROM) or a random access memory (RAM). In an embodiment of the present invention, the memory may be located inside or outside the processor and may be connected to the processor through various known means. The memory may include various forms of volatile or nonvolatile media, for example, may include a ROM or a RAM.

Accordingly, the embodiments of the present invention may be embodied as a method implemented by a computer or non-transitory computer readable media in which computer executable instructions are stored. According to an embodiment, when executed by a processor, computer readable instructions may perform a method according to at least one aspect of the present disclosure.

The communication device 1020 may transmit or receive a wired signal or a wireless signal.

In addition, the method according to the present invention may be implemented in the form of program instructions executable by various computer devices and may be recorded on computer readable media.

The computer readable media may be provided with program instructions, data files, data structures, and the like alone or in combination. The program instructions recorded on the computer readable media may be specially designed and constructed for the purposes of the present invention or may be well-known and available to those skilled in the art of computer software. The computer readable storage media include hardware devices configured to store and execute program instructions. For example, the computer readable storage media include magnetic media such as hard disks, floppy disks, and magnetic tape, optical media such as a compact disc (CD)-ROM and a digital video disk (DVD), magneto-optical media such as floptical disks, a ROM, a RAM, a flash memory, etc. The program instructions include not only machine language code made by a compiler but also high level code that may be used by an interpreter etc., which is executed by a computer.

The memory 1030 is implemented to store instructions readable by a computer, and the at least one processor 1010 is implemented to execute the instructions.

The processor 1010 may be configured to execute the instructions, to thereby preprocess an input image, input the preprocessed image into a deblurring model to generate a restored image, calculate an error between the preprocessed image and the restored image, and train the deblurring model based on the error. The deblurring model includes an encoder and a decoder. Additionally, the processor 1010 may be configured to calculate the error using a calculation method related to at least one of MSE and SSIM. The input image may be an image used for training the deblurring model, and may be a set of images showing various levels of sharpness. Known techniques may be used to express the level of sharpness. The input image may be a one-dimensional image, such as a black and white image, or a three-dimensional image, such as an RGB image.

The processor 1010 may be configured to execute the instructions stored in the memory 1030, to thereby in preprocessing the input image, apply a sharpening technique to the input image such that the edges of the input image are sharpened.

The processor 1010 may be configured to execute the instructions stored in the memory 1030, to thereby input the preprocessed image into the encoder to obtain an encoder output, and input the encoder output into the decoder to generate the restored image.

The processor 1010 may be configured to execute the instructions stored in the memory 1030, to thereby input a deblurring target image into the encoder of the trained deblurring model, apply an image filtering technique to an output of the encoder, and input the encoder output, to which the image filtering technique has been applied, into the decoder of the trained deblurring model to generate a deblurred image. The image filtering technique may be a sharpening technique.

The encoder output may be an image whose size is reduced compared to the deblurring target image. The deblurred image may be an image that has the same size as the deblurring target image.

As is apparent from the above, according to the present invention, a deblurring model and function can be implemented using an unsupervised learning method without a sharp image corresponding to a blurry image, thereby providing easy application to various environments.

According to the present invention, a deblurring function can be implemented through a simple image processing technique without relying on complex functions proposed by the conventional technologies, such as a blur kernel, an artificial neural network model and the like for image processing in a latent space.

According to the present invention, an improved deblurring function can be implemented through processing in a latent space as compared to when directly applying an image filtering technique to the original image.

The effects of the present disclosure are not limited to the effects described above, and other effects that are not described will be clearly understood by those skilled in the art from the above detailed description.

Although the present invention has been described in detail above with reference to exemplary embodiments, those of ordinary skill in the technical field to which the present invention pertains should be able to understand that various modifications and alterations may be made without departing from the technical spirit and scope of the present invention.

What is claimed is:

1. An unsupervised learning method of a deblurring model, which is a method of training an image deblurring model, the method comprising:
preprocessing an input image;
inputting the preprocessed image into a deblurring model to generate a restored image;
calculating an error between the preprocessed image and the restored image; and
training the deblurring model based on the error.

2. The method of claim 1, wherein the input image is a black and white image.

3. The method of claim 1, wherein the preprocessing of the input image includes applying a sharpening technique to the input image to sharpen edges of the input image.

4. The method of claim 1, wherein the deblurring model includes an encoder and a decoder, and
the generating of the restored image includes:
inputting the preprocessed image into the encoder to obtain an output of the encoder; and
inputting the output of the encoder into the decoder to generate the restored image.

5. The method of claim 1, wherein the calculating of the error includes calculating the error using a calculation method related to at least one of mean squared error (MSE) and structural similarity index measure (SSIM).

6. A latent space processing-based deblurring method, which is a method of deblurring an image using a trained deblurring model, the method comprising:
inputting a deblurring target image into an encoder;
applying an image filtering technique to an output of the encoder; and
inputting the output of the encoder, to which the image filtering technique has been applied, into a decoder to generate a deblurred image,
wherein the encoder and the decoder constitute a deblurring model and are trained through an unsupervised learning method.

7. The latent space processing-based deblurring method of claim 6, wherein the output of the encoder is an image whose size is reduced compared to a size of the deblurring target image.

8. The latent space processing-based deblurring method of claim 6, wherein the deblurred image is an image that has the same size as the deblurring target image.

9. The latent space processing-based deblurring method of claim 6, wherein the image filtering technique is a sharpening technique.

10. An apparatus for deblurring based on unsupervised learning and latent space processing, the apparatus comprising
a memory in which instructions readable by a computer are stored; and
at least one processor implemented to execute the instructions,
wherein the at least one processor is configured to execute the instructions to:
preprocess an input image;
input the preprocessed image into a deblurring model to generate a restored image;
calculate an error between the preprocessed image and the restored image; and
train the deblurring model based on the error.

11. The apparatus of claim 10, wherein the at least one processor is configured to, when preprocessing the input image, apply a sharpening technique to the input image to sharpen edges of the input image.

12. The apparatus of claim 10, wherein the deblurring model includes an encoder and a decoder, and
the at least one processor is configured to input the preprocessed image into the encoder to obtain an output of the encoder and input the output of the encoder into the decoder to generate the restored image.

13. The apparatus of claim 10, wherein the at least one processor is configured to calculate the error using a calculation method related to at least one of mean squared error (MSE) and structural similarity index measure (SSIM).

14. The apparatus of claim 10, wherein the at least one processor is configured to:
input a deblurring target image into an encoder of the trained deblurring model;
apply an image filtering technique to an output of the encoder; and
input the output of the encoder, to which the image filtering technique has been applied, into a decoder of the trained deblurring model to generate a deblurred image.

15. The apparatus of claim 14, wherein the output of the encoder is an image whose size is reduced compared to a size of the deblurring target image.

16. The apparatus of claim 14, wherein the image filtering technique is a sharpening technique.
